(19) United States
(12) Patent Application Publication
(10) Pub. No.: US 2025/0114791 A1
(43) Pub. Date: Apr. 10, 2025

(54) CLASSIFICATION METHOD, MICRO FLUID DEVICE, METHOD FOR MANUFACTURING MICRO FLOW CHANNEL, AND METHOD FOR PRODUCING PARTICLE-CONTAINING FLUID

(71) Applicants: CANON MEDICAL SYSTEMS CORPORATION, Otawara-shi (JP); Canon Kabushiki Kaisha, Tokyo (JP)

(72) Inventors: Kohei SARUWATARI, Kawasaki (JP); Yoshihiro KATO, Ohta (JP); Yusuke OWAKI, Moka (JP)

(73) Assignees: CANON MEDICAL SYSTEMS CORPORATION, Otawara-shi (JP); Canon Kabushiki Kaisha, Tokyo (JP)

(21) Appl. No.: 18/907,110

(22) Filed: Oct. 4, 2024

(30) Foreign Application Priority Data
Oct. 6, 2023 (JP) 2023-174363

(51) Int. Cl. B01L 3/00

(52) U.S. Cl. CPC B01L 3/502753; B01L 3/502707; B01L 2300/08

(57) ABSTRACT

A classification method according to an embodiment includes a first step and a second step. At the first step, a fluid is caused to flow into a micro flow channel having a spiral shape. At the second step, target particles as recovery targets contained in the fluid are classified. For a combination of the micro flow channel and the target particle at the second step, a relation of Dₑ/Rₑₚ≤4.68 is established between a particle Reynolds number Rₑₚ and a Dean number Dₑ.

### CROSS-REFERENCE TO RELATED APPLICATIONS

This application is based upon and claims the benefit of priority from Japanese Patent Application No. 2023-174363, filed on Oct. 6, 2023, the entire contents of which are incorporated herein by reference.

### FIELD

Embodiments described herein relate generally to a classification method, a micro fluid device, a method for manufacturing a micro flow channel, and a method for producing a particle-containing fluid.

### BACKGROUND

In recent years, induced pluripotent stem (iPS) cells have attracted attention. Conventionally, it is known that a step of classifying nucleated cells from blood is required to establish iPS cells.

### BRIEF DESCRIPTION OF THE DRAWINGS

FIG. 1 is a diagram for explaining an example of a configuration of a micro fluid device according to a first embodiment;

FIG. 2 is a diagram for explaining an example of a configuration of a droplet generation unit according to the first embodiment;

FIG. 3 is a diagram for explaining an example of particle convergence according to the first embodiment;

FIG. 4 is a diagram for explaining an example of another configuration of a micro flow channel according to the first embodiment;

FIG. 5 is a diagram illustrating a result of an experiment on a relation between Dₑ/Rₑₚ and presence/absence of particle convergence according to the first embodiment;

FIG. 6 is a diagram illustrating a result of an experiment on a relation between Dₑ/Rₑₚ and presence/absence of particle convergence according to the first embodiment;

FIG. 7 is a diagram illustrating a result of an experiment on a relation between Dₑ/Rₑₚ and presence/absence of particle convergence according to the first embodiment;

FIG. 8 is a diagram illustrating a result of an experiment on a relation between Dₑ/Rₑₚ and presence/absence of particle convergence according to the first embodiment;

FIG. 9 is a diagram illustrating a result of an experiment for confirming particle convergence using real cells according to the first embodiment;

FIG. 10 is a diagram illustrating a result of an experiment for confirming particle convergence using real cells according to the first embodiment;

FIG. 11 is a diagram illustrating a result of an experiment for confirming particle convergence using real cells according to the first embodiment;

FIG. 12 is a diagram illustrating a result of a simulation experiment of sending a fluid containing iPS cells according to the first embodiment; and

FIG. 13 is a diagram illustrating a result of an experiment for confirming whether to be able to achieve particle convergence of a plurality of particles with a single flow channel according to the first embodiment.

### DETAILED DESCRIPTION

A classification method according to an embodiment includes a first step and a second step. At the first step, a fluid is caused to flow into a micro flow channel having a spiral shape. At the second step, target particles as recovery targets contained in the fluid are classified. For a combination of the micro flow channel and the target particle at the second step, a relation of Dₑ/Rₑₚ≤4.68 is established between a particle Reynolds number Rₑₚ and a Dean number Dₑ.

The following describes embodiments of a classification method, a micro fluid device, and a method for manufacturing a micro flow channel in detail with reference to the attached drawings. The classification method, the micro fluid device, the method for manufacturing the micro flow channel, and a method for producing a particle-containing fluid according to the present application are not limited to the embodiments described below. In the following description, the same constituent elements are denoted by a common reference numeral, and redundant description will not be repeated.

### First Embodiment

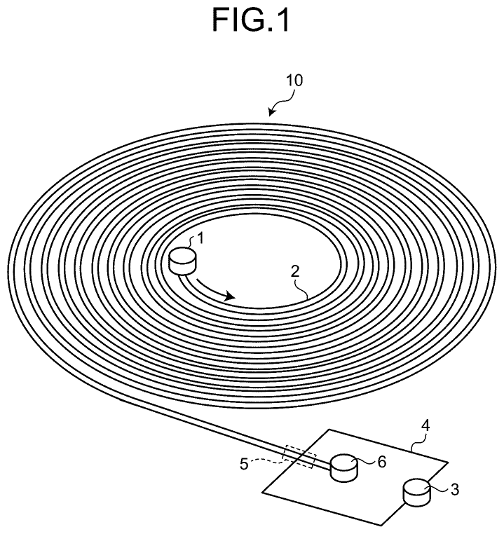

First, the following describes a configuration of a micro fluid device 10 used in a classification method according to a first embodiment. FIG. 1 is a diagram for explaining an example of a configuration of the micro fluid device 10 according to the first embodiment.

As illustrated in FIG. 1, the micro fluid device 10 includes a first fluid supply unit 1, a micro flow channel 2, a second fluid supply unit 3, a flow channel 4, a droplet generation unit 5, and a recovery unit 6, and classifies particles contained in a fluid. Specifically, the micro fluid device 10 separates a plurality of particles contained in the fluid in accordance with sizes (particle diameters) of the particles.

The first fluid supply unit 1 supplies a fluid containing a plurality of particles to the micro flow channel 2. Specifically, the first fluid supply unit 1 supplies a fluid containing a plurality of particles having different particle diameters to the micro flow channel 2. For example, the first fluid supply unit 1 supplies, to the micro flow channel 2, a fluid containing nucleated cells as targets for introducing initializing factors in establishing iPS cells. Herein, the fluid containing nucleated cells may be blood (peripheral blood, cord blood, and the like) containing nucleated cells, or a preserving medium containing nucleated cells in blood.

The first fluid supply unit 1 is, for example, implemented by a syringe pump constituted of a syringe including a cylinder that houses a fluid and a piston for causing the fluid housed in the cylinder to be discharged from a cylinder distal end, a connection part that connects the cylinder distal end with the micro flow channel 2, and a pump for moving the piston. The first fluid supply unit 1 may be implemented by a piston pump, a gear pump, a peristaltic pump, a piezoelectric micropump, and the like instead of the syringe pump.

The first fluid supply unit 1 injects a fluid into the micro flow channel 2. For example, the first fluid supply unit 1 injects the fluid into the micro flow channel 2 at a flow speed with which the particles in the fluid are separated in accordance with the sizes thereof in the micro flow channel 2. A speed for supplying the fluid by the first fluid supply unit 1 (flow speed of the fluid) can be changed depending on a type and the like of the particle to be separated.

The micro flow channel 2 causes the fluid supplied by the first fluid supply unit 1 to flow. The micro flow channel 2 is formed in a spiral shape to have a rectangular cross section, for example. Specifically, the micro flow channel 2 separates the particles contained in the fluid in accordance with the particle diameters by causing lift force and Dean vortex to act on the fluid flowing in the flow channel. For example, the micro flow channel 2 causes nucleated cells and anucleate cells contained in the blood to be separated in the flow channel by the action of the lift force and the Dean vortex.

The second fluid supply unit 3 supplies a continuous phase fluid for generating droplets. The continuous phase fluid is, for example, oil, and oil corresponding to the particle to be enclosed in the droplet is appropriately used.

The flow channel 4 allows the continuous phase fluid supplied from the second fluid supply unit 3 to flow therethrough.

The droplet generation unit 5 generates droplets enclosing the particles. For example, the droplet generation unit 5 is a region in which the micro flow channel 2 through which the fluid containing the particles flows intersects the flow channel 4 through which the continuous phase fluid flows. The micro flow channel 2 is connected with the flow channel 4 in a state in which the flow channel 4 is opposed to the micro flow channel 2 through which the fluid containing the particles flows.

When the fluid containing the particles and the continuous phase fluid are supplied to the droplet generation unit 5, the continuous phase fluid shears the fluid containing the particles, and droplets are generated. For example, the droplet generation unit 5 generates droplets the volume of which is represented by femtoliter (fL) to picoliter (pL). In a case in which a sheared droplet contains a particle, this particle is in a state of being enclosed in the droplet. Thus, the droplet generation unit 5 is an example of an enclosing unit.

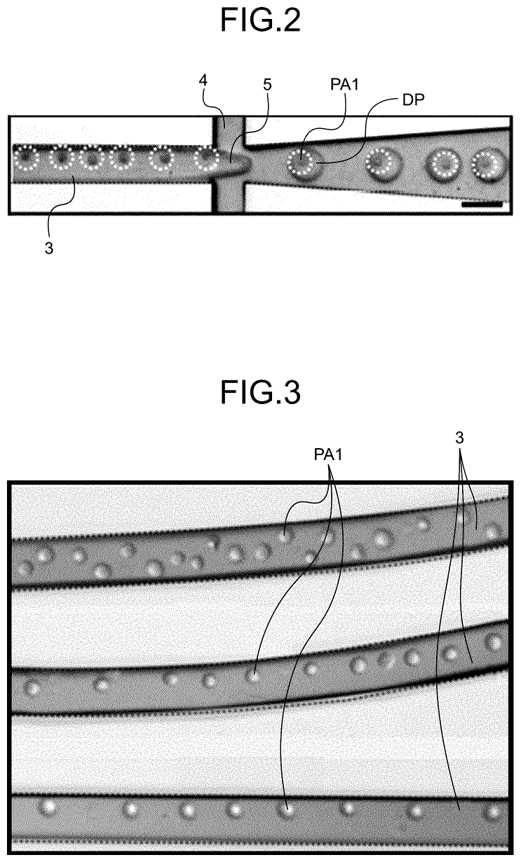

FIG. 2 is a diagram for explaining an example of droplet generation according to the first embodiment. As illustrated in FIG. 2, fluid containing particles PA1 flowing through the micro flow channel 2 is sheared by the continuous phase fluid flowing through the flow channel 4, and droplets DP are generated. In the example of FIG. 2, the fluid containing a single particle is sheared by the continuous phase fluid, and the droplet DP in which the single particle is enclosed is generated.

The recovery unit 6 is connected to the droplet generation unit 5. The recovery unit 6 recovers the droplets generated by the droplet generation unit 5. Accordingly, the recovery unit 6 can recover the particles enclosed in the droplets.

Herein, at the time when the particles contained in the fluid pass through the micro flow channel 2 of the micro fluid device 10, a plurality of hydrodynamic forces caused by a flow of the fluid act on the particles. When the hydrodynamic forces are balanced at a certain point in the micro flow channel 2, a phenomenon may occur such that streamlines of the particles become one streamline in the micro flow channel 2 (hereinafter, also referred to as particle convergence).

FIG. 3 is a diagram for explaining an example of particle convergence according to the first embodiment. As illustrated in an upper part of FIG. 3, in the vicinity of an inlet of a spiral of the micro flow channel 2, the particles PA1 in the micro flow channel 2 are dispersed on an inner side and an outer side of the micro flow channel 2. As the particles travel in a direction toward the recovery unit 6 in the micro flow channel 2, as illustrated in an intermediate part of FIG. 3, the particles start to converge to the inner side of the micro flow channel 2. In the vicinity of an outlet of the spiral of the micro flow channel 2, as illustrated in a lower part of FIG. 3, the particles in the micro flow channel 2 are caused to be in a state of converging to the inner side of the micro flow channel 2.

FIG. 3 exemplifies a case in which particle convergence is caused on the inner side of the micro flow channel 2, but particle convergence may be caused in the vicinity of the center of the micro flow channel 2.

In this way, by causing particle convergence in the micro flow channel 2, a probability of shearing between the particles is increased at the time when the continuous phase fluid shears the fluid containing the particles. In other words, it is possible to increase a probability of obtaining a droplet containing a single particle by causing particle convergence. That is, it can be said that causing particle convergence in the micro flow channel 2 leads to efficiently recovering a target particle as a recovery target.

The present embodiment describes an example in which the first fluid supply unit 1 is disposed on a wall surface side close to the center of the spiral of the micro flow channel 2, and the recovery unit 6 is disposed on the outer side of the spiral. However, the first fluid supply unit 1 may be disposed on the outer side of the spiral, and the recovery unit 6 may be disposed on the wall surface side close to the center of the spiral. In this case, the recovery unit 6 may be disposed in the vicinity of the center of the spiral of the micro flow channel 2. Additionally, in this case, the micro fluid device 10 does not necessarily perform an operation related to droplet generation.

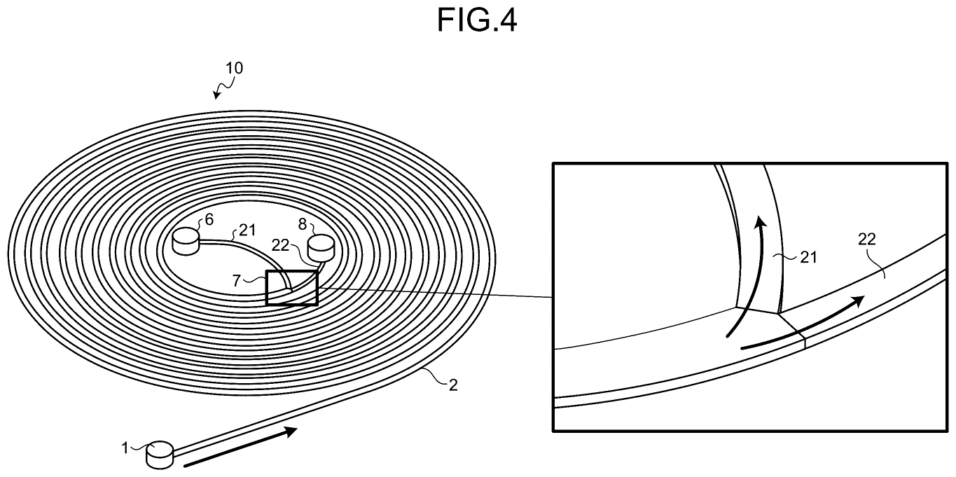

Herein, FIG. 4 is a diagram for explaining an example of another configuration of the micro fluid device 10 according to the first embodiment. Hereinafter, differences from FIG. 1 will be described, and points common to FIG. 1 will not be repeated.

In the configuration of FIG. 4, the first fluid supply unit 1 is disposed on the outer side of the spiral of the micro flow channel 2, and the recovery unit 6 is disposed in the vicinity of the center of the spiral of the micro flow channel 2. In the configuration of FIG. 4, the micro fluid device 10 includes a branch part 7, a flow channel 21, a flow channel 22, and a waste liquid unit 8. The following description is based on the assumption that particle convergence is caused on the inner side of the micro flow channel 2.

The branch part 7 causes the micro flow channel 2 to branch into the flow channel 21 and the flow channel 22. Specifically, the branch part 7 causes the micro flow channel 2 to branch to cause a fluid containing particle-converged target particles and a fluid containing particles other than the target particles to flow into the flow channel 21 and the flow channel 22, respectively. For example, as illustrated in FIG. 4, in the micro flow channel 2 formed in a spiral shape, the branch part 7 causes the fluid containing particle-converged particles flowing on the inner side of a flow direction to flow into the flow channel 21, and causes the fluid containing the other particles to flow into the flow channel 22.

The flow channel 21 is a flow channel branched off from the micro flow channel 2 by the branch part 7, and connected to the recovery unit 6. The fluid containing the target particles caused to flow on the inner side of the flow direction in the micro flow channel 2 is caused to flow into the flow channel 21. The flow channel 21 causes the flowed-in fluid containing the target particles to be discharged to the recovery unit 6. In this case, the fluid containing the target particles is an example of an output fluid and a particle-containing fluid.

Herein, the target particles are various cells, for example. The fluids are various liquid culture media, for example. Thus, it can also be said that the liquid culture medium containing cells recovered by the method described above is a cell suspension obtained by suspending cells in the liquid culture medium. Generally, the cell suspension is circulated in a market as a single item. Thus, it can also be said that the method described above in a case of assuming that the target particle is a cell and the fluid is a liquid culture medium is a method for producing a cell suspension as a product (particle-containing fluid).

The flow channel 22 is a flow channel branched off from the micro flow channel 2 by the branch part 7, and connected to the waste liquid unit 8. The particles other than the target particles caused to flow on the inner side of the flow direction in the micro flow channel 2 are caused to flow into the flow channel 22. The flow channel 22 causes the flowed-in particles other than the target particle to be discharged to the waste liquid unit 8.

The waste liquid unit 8 is disposed on the wall surface side close to the center of the spiral of the micro flow channel 2. The waste liquid unit 8 is connected to the flow channel 22, and recovers, as a waste liquid, the fluid containing the particles other than the target particles caused to flow in the flow channel 22.

The recovery unit 6 and the waste liquid unit 8 in FIG. 4 may be exchanged. For example, in a case in which particle convergence is caused in the vicinity of the center of the micro flow channel 2, particles that are not particle-converged are largely affected by force of the fluid flowing toward the inner side of the spiral in the micro flow channel 2. Thus, the particles that are not particle-converged may be caused to flow on the inner side of the flow direction of the micro flow channel 2 with high possibility. Accordingly, in a case in which particle convergence is caused in the vicinity of the center of the micro flow channel 2, it can be considered that the particles other than the target particles are caused to flow into the flow channel 21.

On the other hand, the target particles that are particle-converged in the vicinity of the center of the micro flow channel 2 are less likely to move toward the inner side of the flow direction of the micro flow channel 2. Thus, it can be considered that the target particles that are particle-converged in the vicinity of the center of the micro flow channel 2 are caused to flow into the flow channel 22.

Based on the above description, in a case in which particle convergence is caused in the vicinity of the center of the micro flow channel 2, it is preferable to dispose the recovery unit 6 on the wall surface side close to the center of the spiral of the micro flow channel 2.

The configuration of the micro fluid device 10 used in the classification method according to the first embodiment has been described above. As described above, whether particle convergence is caused in classification using the micro flow channel is an important matter for efficiently recovering the cells. Conventionally, as parameters related to particle convergence, the particle Reynolds number Rₑₚ and the Dean number Dₑ are known.

The particle Reynolds number Rₑₚ is a dimensionless number representing motion of the particle in the fluid. The particle Reynolds number Rₑₚ is represented by the following expression (1) in a case of assuming that a fluid density (kg/m³) is ρ, an average flow speed (m/s) is U, a particle diameter (m) is aₚ, a fluid viscosity (Pa·s) is μ, and a hydraulic diameter (m) is Dₕ.

$$R {e}_{p} = \frac{ρ {Ua}_{p}^{2}}{μ {D}_{h}} \qquad ( 1 )$$

The Dean number Dₑ is a dimensionless number representing a flow in a flow channel having a curvature. The Dean number Dₑ is represented by the following expression (2) in a case of assuming that a flow channel curvature (1/m) is R.

$$De = \frac{ρ {UD}_{h}}{μ} \times \sqrt{\frac{{D}_{h}}{2 R}} \qquad ( 2 )$$

The present applicants have found that, through previous experiences, there is the possibility that a relation between the particle Reynolds number Rₑₚ and the Dean number Dₑ is related to particle convergence. More specifically, they have made the inference that a parameter of Dₑ/Rₑₚ is important for particle convergence. Thus, the present applicants performed an experiment on a relation between Dₑ/Rₑₚ and presence/absence of particle convergence.

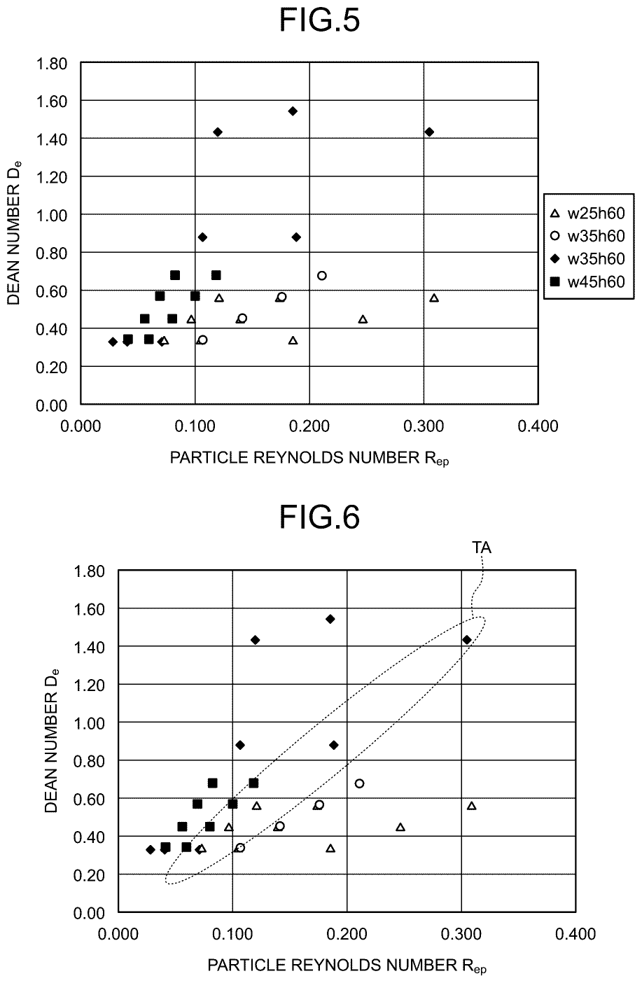

The following describes results of the experiment on the relation between Dₑ/Rₑₚ and presence/absence of particle convergence with reference to FIG. 5 to FIG. 8. FIG. 5 to FIG. 8 are diagrams illustrating results of the experiment on the relation between Dₑ/Rₑₚ and presence/absence of particle convergence according to the first embodiment.

### Experimental Example 1: Experiment on Relation Between Dₑ/Rₑₚ and Presence/Absence of Particle Convergence

### Experimental Procedure

A plurality of the micro flow channels 2 each having a rectangular cross section were prepared. Specifically, prepared were three micro flow channels 2 (designed by the present applicants) having a width of 25 μm×a depth of 60 μm, a width of 35 μm×a depth of 60 μm, and a width of 45 μm×depth 60 μm. The width of the micro flow channel 2 is a length in a longitudinal direction of the rectangle, and the depth is a length in a lateral direction of the rectangle. As particles to be sent, prepared were bead particles (Duke Standards TM 4205A, 4206A, and 4208A (Thermo Scientifics)) having diameters of 5 μm, 6 μm, and 8 μm.

The prepared bead particles having the diameters of 5 μm, 6 μm, and 8 μm were dispersed in a dispersion medium (OTSUKA DISTILLED WATER, The Pharmacopoeia of Japan, water for injection, (Otsuka Pharmaceutical Factory, Inc.)). To prevent the particles from precipitating due to a density difference between beads and distilled water, density was adjusted by using a density adjusting reagent (Optiprep TM, Serumwerk Bernburg AG). Through each of the three prepared micro flow channels 2, each of the dispersion media respectively including the bead particles having the diameters of 5 μm, 6 μm, and 8 μm was sent as a single item under a plurality of flow rate conditions (average flow speed) using a syringe pump (PHD ULTRA series, model number 70-3007 (Harvard Apparatus)). For a combination of the micro flow channel 2 and the bead particles, particle behavior of the bead particles in each of the flow channels was photographed. A moving image obtained by photographing the particle behavior was analyzed to confirm presence/absence of particle convergence.

For each combination of the bead particles and the micro flow channel 2 through which the dispersion medium was sent, the particle Reynolds number Rₑₚ and the Dean number Dₑ were calculated. The particle Reynolds number Rₑₚ indicated by a horizontal axis (X-axis) and the Dean number Dₑ indicated by the vertical axis (Y-axis) were plotted together with information representing presence/absence of particle convergence. The average flow speed U was obtained by dividing the flow rate by the cross sectional area (width×depth) of the micro flow channel 2.

Calculation results of the particle Reynolds number Rₑₚ and the Dean number Dₑ calculated by the procedure described above are indicated by the following Table 1 to Table 3. Table 1 summarizes the calculation results about the micro flow channel 2 having a width of 25 μm×a depth 60 μm. Table 2 summarizes the calculation results about the micro flow channel 2 having a width of 35 μm×a depth of 60 μm. Table 3 summarizes the calculation results about the micro flow channel 2 having a width of 45 μm×a depth of 60 μm.

TABLE 1

| | Flow channel shape (width × depth) | | | | | | | | |
|---|---|---|---|---|---|---|---|---|---|
| | W25 × H60 | | | | | | | | |
| | Particle diameter (bead) | | | | | | | | |
| | 5 μm | | | 6 μm | | | 8 μm | | |
| Flow rate condition | 15 | 20 | 25 | 15 | 20 | 25 | 15 | 20 | 25 |
| (μL/min) | | | | | | | | | |
| Particle Reynolds | 0.07 | 0.10 | 0.12 | 0.10 | 0.14 | 0.17 | 0.18 | 0.24 | 0.31 |
| number Rep | | | | | | | | | |
| Dean number De | 0.39 | 0.52 | 0.65 | 0.39 | 0.52 | 0.65 | 0.39 | 0.52 | 0.65 |

TABLE 2

| | Flow channel shape (width × depth) | | | | | | | | | | | |
|---|---|---|---|---|---|---|---|---|---|---|---|---|
| | W35 × H60 | | | | | | | | | | | |
| | Particle diameter (bead) | | | | | | | | | | | |
| | 5 μm | | | | 6 μm | | | | 8 μm | | | |
| Flow rate condition | 15 | 20 | 25 | 30 | 15 | 20 | 25 | 30 | 15 | 20 | 25 | 30 |
| (μL/min) | | | | | | | | | | | | |
| Particle Reynolds | 0.04 | 0.05 | 0.07 | 0.08 | 0.06 | 0.08 | 0.10 | 0.12 | 0.10 | 0.14 | 0.17 | 0.21 |
| number Rep | | | | | | | | | | | | |
| Dean number De | 0.39 | 0.52 | 0.65 | 0.78 | 0.39 | 0.52 | 0.65 | 0.78 | 0.39 | 0.52 | 0.65 | 0.78 |

TABLE 3

| | Flow channel shape (width × depth) | | | | | | | |
|---|---|---|---|---|---|---|---|---|
| | W45 × H60 | | | | | | | |
| | Particle diameter (bead) | | | | | | | |
| | 5 μm | | 6 μm | | | 8 μm | | |
| Flow rate | 15 | 45 | 15 | 40 | 70 | 15 | 40 | 65 |
| condition | | | | | | | | |
| (μL/min) | | | | | | | | |
| Particle | 0.03 | 0.08 | 0.04 | 0.10 | 0.18 | 0.07 | 0.19 | 0.30 |
| Reynolds | | | | | | | | |
| number Rep | | | | | | | | |
| Dean | 0.38 | 1.14 | 0.38 | 1.01 | 1.77 | 0.38 | 1.01 | 1.64 |
| number De | | | | | | | | |

A graph created by the procedure described above is illustrated in FIG. 5. In FIG. 5, the horizontal axis indicates the particle Reynolds number Rₑₚ, and the vertical axis indicates the Dean number Dₑ. Respective plots have different shapes and colors depending on a type of the micro flow channel 2 used for sending the fluid and presence/absence of particle convergence.

A white triangular plot represents that the fluid is sent by using the micro flow channel 2 having a width of 25 μm×a depth of 60 μm, and particle convergence is confirmed. A white circular plot represents that the fluid is sent by using the micro flow channel 2 having a width of 35 μm×a depth of 60 μm, and particle convergence is confirmed. A black diamond plot represents that the fluid is sent by using the micro flow channel 2 having a width of 35 μm×a depth of 60 μm, and no particle convergence is confirmed. A black square plot represents that the fluid is sent by using the micro flow channel 2 having a width of 45 μm×a depth of 60 μm, and no particle convergence is confirmed.

FIG. 6 is a diagram illustrating a region TA in which a threshold Th of Dₑ/Rₑₚ is present. The present applicants estimated that, from the graph in FIG. 5, the threshold Th of Dₑ/Rₑₚ for determining presence/absence of particle convergence fell within the region TA based on a positional relation between a plot with which particle convergence was confirmed and a plot with which no particle convergence was confirmed.

Thus, the present applicants calculated a maximum value of an inclination of a straight line passing through an origin (Rₑₚ=0, Dₑ=0) of the graph and each white plot (that is, a value of Dₑ/Rₑₚ), and a minimum value of an inclination of a straight line passing through the origin of the graph and each black plot. Table 4 indicates a calculation result of the maximum value of the inclination of the straight line passing through the origin of the graph and each white plot, and the minimum value of the inclination of the straight line passing through the origin of the graph and each black plot.

TABLE 4

| | Inclination |
|---|---|
| White plot (convergence ∘) | 4.680 |
| Black plot (convergence x) | 4.686 |

As indicated by Table 1, it was confirmed that the minimum value of the inclination of the straight line passing through the origin of the graph and each black plot is larger than the maximum value of the inclination of the straight line passing through the origin of the graph and each white plot. Thus, based on the calculation result, the present applicants defined the threshold Th of Dₑ/Rₑₚ for determining presence/absence of particle convergence to be Th=4.68.

In the present embodiment, it is assumed that significant digits of Th are three digits and Th=4.68, but the significant digits of Th are not limited to three digits. For example, the significant digits may be two digits (Th=4.6) or four digits (Th=4.680) in accordance with significant digits of the fluid density ρ, the average flow speed U, the particle diameter aₚ, the fluid viscosity μ, the hydraulic diameter Dh, and the flow channel curvature R.

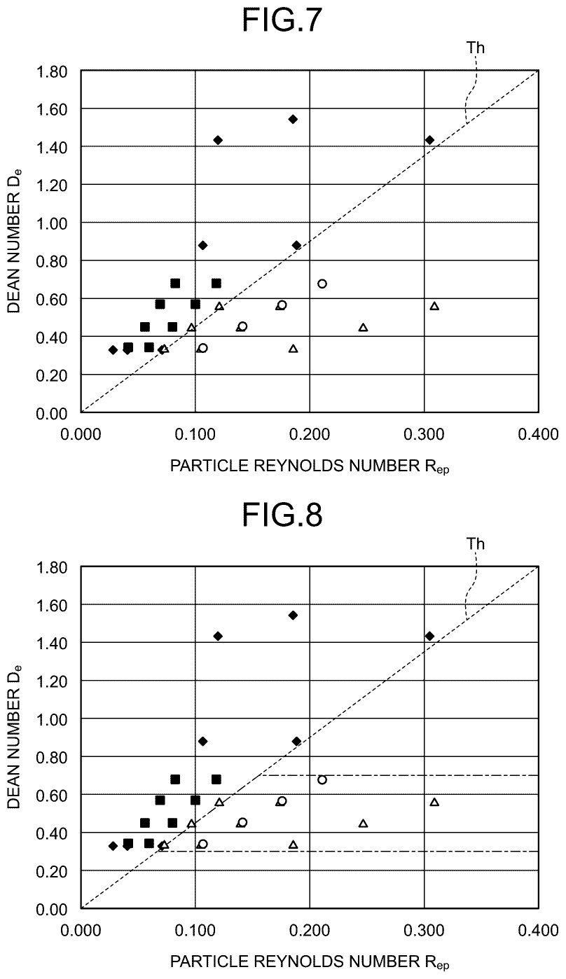

Herein, FIG. 7 is a graph combining the respective plots and information representing the threshold Th of Dₑ/Rₑₚ. As illustrated in FIG. 7, the threshold Th is represented as a straight line representing Y=4.68X on the graph assuming that the horizontal axis is the X-axis and the vertical axis is the Y-axis. On the graph of FIG. 7, in a case in which Dₑ/Rₑₚ>4.68 is satisfied, it can be determined that particle convergence is not caused. Similarly, in a case in which Dₑ/Rₑₚ≤4.68 is satisfied, it can be determined that particle convergence is caused. The case in which Dₑ/Rₑₚ<4.68 is satisfied may be set as a condition for determining that particle convergence is caused.

Based on the result of Experimental example 1, the present applicants calculated a numerical range of the particle Reynolds number Rₑₚ and a numerical range of the Dean number Dₑ with which particle convergence was actually confirmed. FIG. 8 illustrates a graph representing the numerical range of the particle Reynolds number Rₑₚ and the numerical range of the Dean number Dₑ with which particle convergence is actually confirmed.

As illustrated in FIG. 8, a region AA represented by alternate long and short dash lines represents a region in which particle convergence is actually confirmed. Specifically, the region AA is a region satisfying both of 0.071<Rₑₚ and 0.38<Dₑ<0.78. The present applicants confirmed that all white plots included in the region AA satisfied Dₑ/Rₑₚ≤4.68.

Next, the present applicants performed an experiment for confirming whether particle convergence is caused when Dₑ/Rₑₚ≤4.68 was satisfied using real cells.

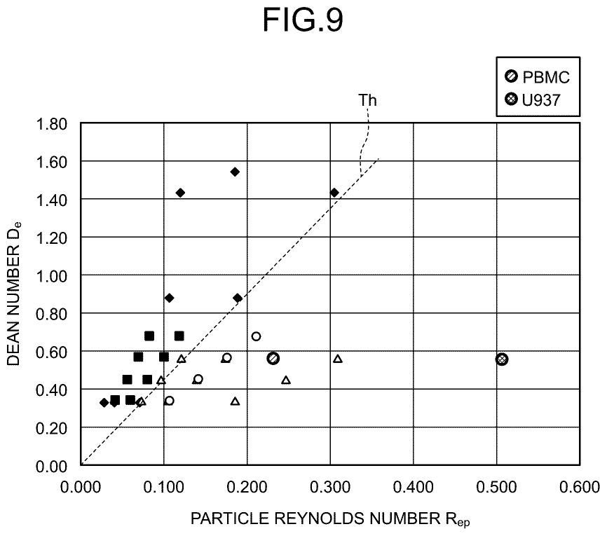

The following describes results of the experiment for confirming particle convergence using real cells with reference to FIG. 9 to FIG. 11. FIG. 9 to FIG. 11 are diagrams illustrating results of the experiment for confirming particle convergence using real cells according to the first embodiment.

### Experimental Example 2: Results of Experiment for Confirming Particle Convergence Using Real Cells

### Experimental Procedure

As fluids containing real cells, prepared were a liquid culture medium containing human peripheral blood mononuclear cells (PBMC) (PRECISION for medicine 33000-10M, Lot: 3010116135) (hereinafter, also referred to as a PBMC solution), and a liquid culture medium containing U937 cells (JCRB9021) as cells derived from a lymphoma (hereinafter, referred to as a U937 solution). For each of the PBMC solution and the U937 solution, the micro flow channel 2 satisfying Dₑ/Rₑₚ≤4.68 was selected assuming that the flow rate was 15 μL/min.

The PBMC solution was sent at the flow rate of 15 μL/min using the selected micro flow channel 2 having a width of 30 μm×a depth of 60 μm (designed by the present applicants). Similarly, the U937 solution was sent at the flow rate of 15 μL/min using the selected micro flow channel 2 having a width of 30 μm×a depth of 60 μm (designed by the present applicants). The same syringe pump as that in the experimental example 1 was used for sending the solution. For each of the PBMC and the U937, particle behavior in the flow channel was photographed. For each of the PBMC and the U937, a moving image obtained by photographing the particle behavior was analyzed to confirm presence/absence of particle convergence.

In FIG. 9, for a combination of the selected micro flow channel 2 and the PBMC, and a combination of the selected micro flow channel 2 and the U937, calculation results of the particle Reynolds number Rₑₚ and the Dean number Dₑ are plotted on the graph illustrated in FIG. 7. For each of them, the micro flow channel 2 satisfying Dₑ/Rₑₚ≤4.68 is selected, so that it can be confirmed that both of them satisfy Dₑ/Rₑₚ≤4.68 as illustrated in FIG. 7.

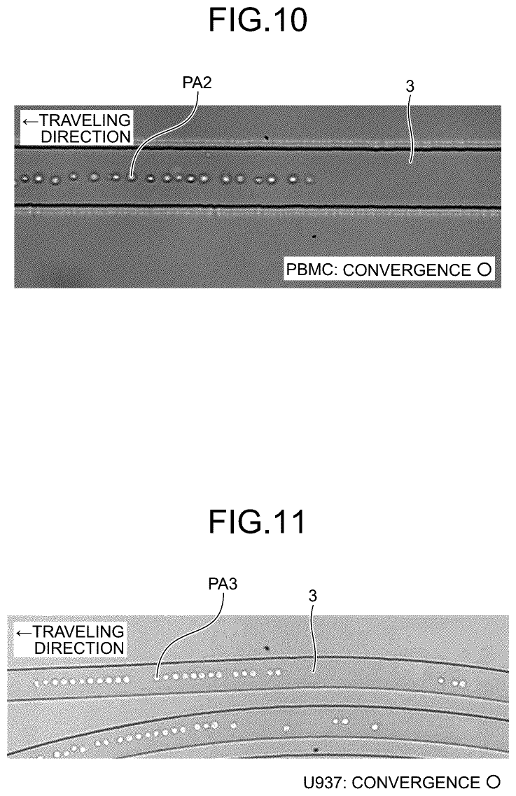

FIG. 10 is an image obtained by photographing particle behavior of the PBMC in the micro flow channel 2. As illustrated in FIG. 10, it was confirmed that particles PA2 (PBMC) were aligned in the vicinity of the center of the micro flow channel 2. Thus, it was confirmed that particle convergence was able to be caused when Dₑ/Rₑₚ≤4.68 was satisfied even in a case in which the PBMC was sent.

FIG. 11 is an image obtained by photographing particle behavior of the U937 in the micro flow channel 2. As illustrated in FIG. 11, it was confirmed that particles PA3 (U937) were aligned in the vicinity of the center of the micro flow channel 2. Thus, it was confirmed that particle convergence was able to be caused when Dₑ/Rₑₚ≤4.68 was satisfied even in a case in which the U937 was sent.

Based on the results of the experimental example 2 described above, it was confirmed that particle convergence was able to be caused with real cells when Dₑ/Rₑₚ≤4.68 was satisfied.

Next, the present applicants performed an experiment for simulating whether to be able to cause particle convergence of iPS cells using the micro flow channel 2 selected in the experimental example 2 with which particle convergence of the PBMC and the U937 was confirmed.

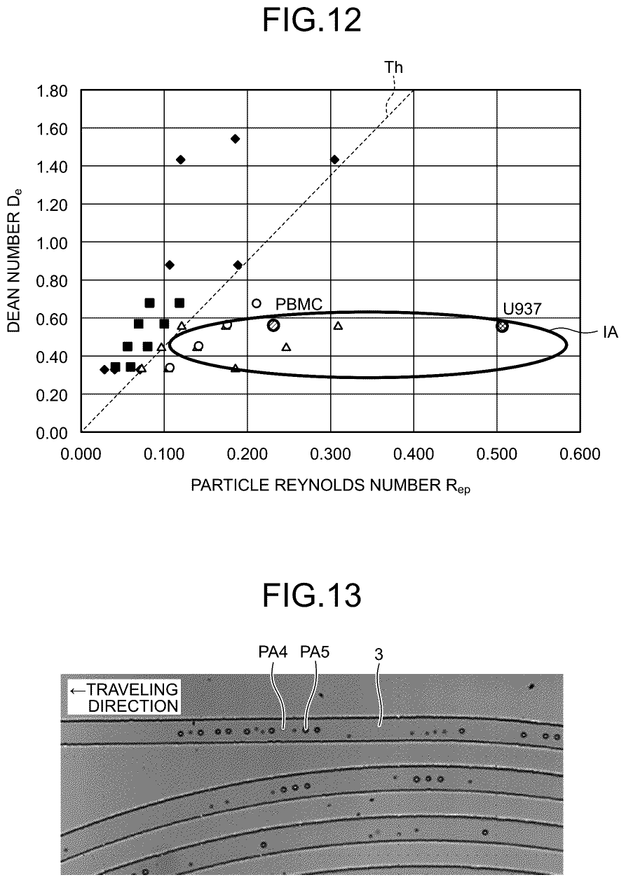

The following describes results of the simulation experiment on iPS cells with reference to FIG. 12. FIG. 12 is a diagram illustrating a result of the simulation experiment on iPS cells according to the first embodiment.

### Experimental Example 3: Results of Simulation Experiment on iPS Cells

### Experimental Procedure

First, it was assumed to send iPS cells each having a particle diameter from 8 to 30 μm, which is a typical particle diameter of the iPS cell. Regarding the assumed iPS cells each having a particle diameter from 8 to 30 μm, for each combination of the iPS cell and the micro flow channel 2 having a width of 30 μm×a depth of 60 μm selected in the experimental example 2, the particle Reynolds number Rₑₚ and the Dean number Dₑ were calculated assuming that the flow rate was 15 to 25 μL/min. The calculation result was plotted on the graph illustrated in FIG. 7, and distribution of plots was confirmed.

The calculation result of the particle Reynolds number Rₑₚ was represented as Rₑₚ=0.054 to 3.24. The calculation result of the Dean number Dₑ was represented as Dₑ=0.34 to 0.57. Minimum values of both of the particle Reynolds number Rₑₚ and the Dean number Dₑ were obtained when the particle diameter was 8 μm and the flow rate was 15 μL/min, and maximum values thereof were obtained when the particle diameter was 15 μm and the flow rate was 25 μL/min. Herein, FIG. 12 is a graph summarizing calculation results of the particle Reynolds number Rₑₚ and the Dean number Dₑ for the combination of the iPS cell and the micro flow channel 2 selected in the experimental example 2. A region IA in FIG. 12 indicates distribution of plots representing the calculation results of the particle Reynolds number Rₑₚ and the Dean number Dₑ.

As illustrated in FIG. 12, all regions within the region TA satisfy Dₑ/Rₑₚ≤4.68. Due to this, it was confirmed that there was a high possibility that particle convergence was able to be caused in a case of sending a fluid containing iPS cells to the micro flow channel 2 selected in the experimental example 2.

Next, the present applicants performed an experiment for confirming whether to be able to cause particle convergence of a plurality of particles with a single flow channel using Dₑ/Rₑₚ≤4.68.

The following describes a result of the experiment for confirming whether to be able to cause particle convergence of a plurality of particles with a single flow channel with reference to FIG. 13. FIG. 13 is a diagram illustrating a result of the experiment for confirming whether to be able to cause particle convergence of a plurality of particles with a single flow channel according to the first embodiment.

### Experimental Example 4: Results of Experiment for Confirming Whether to be Able to Cause Particle Convergence of Plurality of Particles with Single Flow Channel

### Experimental Procedure

First, a plurality of flow channel shapes were optionally set with reference to flow channel shapes that had been used in examination or experiments previously performed by the present applicants. Specifically, seventeen flow channel shapes were set with different combinations of the width and the depth of the flow channel.

Regarding the respective set flow channel shapes, assuming a case of sending particles having a plurality of particle diameters, the particle Reynolds number Rₑₚ and the Dean number Dₑ were calculated. Specifically, assuming a case of sending a fluid containing nine particles respectively having particle diameters of 3, 4, 5, 6, 8, 10, 12, 15, and 20 μm at an average flow speed of 15 μL/min, the particle Reynolds number Rₑₚ and the Dean number Dₑ were calculated.

Based on the calculation results of the particle Reynolds number Rₑₚ and the Dean number Der the flow channel shape for actually sending the fluid was selected. Specifically, assuming a case of sending a fluid containing bead particles of 5 μm and bead particles of 10 μm at the average flow speed of 15 μL/min, a flow channel shape satisfying Dₑ/Rₑₚ≤4.68 for both of the bead particles of 5 μm and the bead particles of 10 μm was selected as a candidate for the flow channel shape used for sending the fluid from among the seventeen flow channel shapes (refer to Table 5). Due to a possibility of clogging of the particles, a flow channel having a minimum dimension smaller than two times of 15 μm was excluded from candidates.

One flow channel shape was selected from among the selected candidates, and the fluid containing the bead particles of 5 μm and the bead particles of 10 μm was sent at the average flow speed of 15 μL/min using the micro flow channel 2 having that flow channel shape. For the bead particles of 5 μm and the bead particles of 10 μm, particle behavior in the flow channel was photographed. For the bead particles of 5 μm and the bead particles of 10 μm, a moving image obtained by photographing the particle behavior was analyzed to confirm presence/absence of particle convergence.

As Table 5, there is provided a table summarizing the flow channel shapes that are optionally set and information representing whether Dₑ/Rₑₚ≤4.68 is satisfied. In the Table, “O” of “Particle diameter of particle to be sent” represents that Dₑ/Rₑₚ≤4.68 is satisfied, and “X” represents that Dₑ/Rₑₚ≤4.68 is not satisfied.

TABLE 5

| | Flow channel | | Particle diameter of particle to be sent | | | | | | | | |
|---|---|---|---|---|---|---|---|---|---|---|---|
| | shape | | 3 | 4 | 5 | 6 | 8 | 10 | 12 | 15 | 20 |
| | Width | Depth | μm | μm | μm | μm | μm | μm | μm | μm | μm |
| 1 | 25 | 60 | x | x | ∘ | ∘ | ∘ | ∘ | ∘ | ∘ | ∘ |
| 2 | 30 | 60 | x | x | x | ∘ | ∘ | ∘ | ∘ | ∘ | ∘ |
| 3 | 30 | 30 | x | ∘ | ∘ | ∘ | ∘ | ∘ | ∘ | ∘ | ∘ |
| 4 | 30 | 25 | x | ∘ | ∘ | ∘ | ∘ | ∘ | ∘ | ∘ | ∘ |
| 5 | 35 | 60 | x | x | x | x | ∘ | ∘ | ∘ | ∘ | ∘ |
| 6 | 35 | 30 | x | ∘ | ∘ | ∘ | ∘ | ∘ | ∘ | ∘ | ∘ |
| 7 | 35 | 35 | x | x | ∘ | ∘ | ∘ | ∘ | ∘ | ∘ | ∘ |
| 8 | 35 | 25 | x | ∘ | ∘ | ∘ | ∘ | ∘ | ∘ | ∘ | ∘ |
| 9 | 35 | 20 | ∘ | ∘ | ∘ | ∘ | ∘ | ∘ | ∘ | ∘ | ∘ |
| 10 | 40 | 30 | x | x | ∘ | ∘ | ∘ | ∘ | ∘ | ∘ | ∘ |
| 11 | 40 | 35 | x | x | ∘ | ∘ | ∘ | ∘ | ∘ | ∘ | ∘ |
| 12 | 40 | 40 | x | x | x | ∘ | ∘ | ∘ | ∘ | ∘ | ∘ |
| 13 | 45 | 35 | x | x | x | ∘ | ∘ | ∘ | ∘ | ∘ | ∘ |
| 14 | 45 | 45 | x | x | x | x | ∘ | ∘ | ∘ | ∘ | ∘ |
| 15 | 50 | 30 | x | x | x | ∘ | ∘ | ∘ | ∘ | ∘ | ∘ |
| 16 | 50 | 40 | x | x | x | x | ∘ | ∘ | ∘ | ∘ | ∘ |
| 17 | 60 | 40 | x | x | x | x | ∘ | ∘ | ∘ | ∘ | ∘ |

As indicated by Table 5, among the seventeen flow channel shapes that were optionally set, the flow channel shapes of 1, 3, 6, 7, 8, 9, 10, and 11 satisfied Dₑ/Rₑₚ≤4.68. Among these, the flow channel shapes of 1, 8, and 9 were excluded from the candidates because a minimum dimension of the flow channel was smaller than two times of 15 μm, and the flow channel shapes of 3, 6, 7, 10, and 11 were selected as the candidates. Among these candidates, the flow channel shape of 11 (width of 40 μm×depth of 30 μm) was selected as a flow channel actually used for sending the fluid.

Herein, FIG. 13 is an image obtained by photographing particle behavior of the bead particles of 5 μm and the bead particles of 10 μm in the micro flow channel 2. As illustrated in FIG. 13, it was confirmed that both of bead particles PA4 of 5 μm and bead particles PA5 of 10 μm were aligned in the vicinity of the center of the micro flow channel 2. Thus, it was confirmed that particle convergence of particles having a plurality of particle diameters was able to be caused in a single flow channel when each of the particles having a plurality of particle diameters satisfied Dₑ/Rₑₚ≤4.68.

As described above, in the classification method according to the first embodiment, for the combination of the micro flow channel 2 and the target particle as the recovery target, the relation of Dₑ/Rₑₚ≤4.68 is established between the particle Reynolds number Rₑₚ and the Dean number Dₑ.

As described above, in a case in which the relation of Dₑ/Rₑₚ≤4.68 is established between the particle Reynolds number Rₑₚ and the Dean number Dₑ, it is estimated that particle convergence of the target particles is caused in the micro flow channel 2. Thus, in selecting the flow channel, if the particle Reynolds number Rₑₚ and the Dean number Dₑ are calculated by using the assumed target particles and flow speed, it is possible to determine whether particle convergence of the target particles is caused in the flow channel. That is, the classification method according to the present embodiment facilitates selection of the flow channel in the classification method using fluid power acting on the particles.

Alternatively, classification may be performed by using the micro flow channel 2 with which Rₑₚ>0.071 and 0.38<Dₑ<0.78 are further established in addition to the fact that the relation of Dₑ/Rₑₚ≤4.68 is established. As described above, it has been experimentally confirmed that, in a case in which Rₑₚ>0.071 and 0.38<Dₑ<0.78 are further established, particle convergence of the target particles is caused in the micro flow channel 2. Due to this, it is possible to further increase the probability that particle convergence of the target particles is caused in the micro flow channel 2. That is, the classification method according to the present embodiment can increase accuracy of particle convergence in the classification method using the fluid power acting on the particles.

As described above, in the classification method according to the present embodiment, even in a case in which there are a plurality of the target particles having different particle diameters, particle convergence of the target particles can be caused in the single micro flow channel 2 so long as the relation of Dₑ/Rₑₚ≤4.68 is established for a combination of each of the target particles and the single micro flow channel 2. Thus, the target particles can be efficiently recovered with the single flow channel without selecting (or designing) the flow channel for each of the particle diameters of the target particles. That is, the classification method according to the present embodiment facilitates selection of the flow channel in the classification method using fluid power acting on the particles.

### Second Embodiment

In the first embodiment described above, the classification method using the micro fluid device 10 is described. The present embodiment describes a method for manufacturing the micro flow channel 2 of the micro fluid device 10.

In the method for manufacturing the micro flow channel according to the present embodiment, first, a combination of an assumed target particle and a condition for sending the fluid is set. A plurality of the particles may be set as targets. Next, manufactured is a spiral-shaped metal mold in which a minimum dimension of the flow channel is equal to or larger than two times the particle diameter of the particle having the largest particle diameter among the set target particles, the metal mold having, in the vicinity of the center, a core with a width and a depth satisfying the relation of Dₑ/Rₑₚ≤4.68. By performing injection molding with a resin material using the metal mold, the micro flow channel 2 of the micro fluid device 10 is formed.

The example of forming the micro flow channel by injection molding is described above, but a method for forming the micro flow channel is not limited to injection molding. For example, the micro flow channel may be formed by blow molding such that a pipe-shaped member made of resin is set in the metal mold, air is caused to flow into the metal mold to inflate the pipe-shaped member, and the pipe-shaped member is brought into intimate contact with a wall surface of the metal mold to be cooled and solidified. Alternatively, for example, the micro flow channel may be formed by extrusion molding such that a high pressure is applied to a material in a mold, and the material is extruded from a slight gap having a certain cross-sectional shape.

With the method for manufacturing the micro flow channel according to the present embodiment, it is possible to easily manufacture the micro flow channel 2 of the micro fluid device 10 with which particle convergence can be caused in the flow channel in a case of sending the fluid using a combination of the assumed target particle and the condition for sending the fluid.

According to at least one of the embodiments described above, it is possible to facilitate selection of the flow channel in the classification method using the fluid power acting on the particles.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A classification method comprising:
causing a fluid to flow into a micro flow channel having a spiral shape; and
classifying target particles as recovery targets contained in the fluid, wherein
a relation of Dₑ/Rₑₚ≤4.68 is established between a particle Reynolds number Rₑₚ and a Dean number Dₑ for a combination of the micro flow channel and the target particle at the classifying.

2. The classification method according to claim 1, wherein Rₑₚ>0.071 and 0.38<Dₑ<0.78 are further established for the combination of the micro flow channel and the target particle.

3. The classification method according to claim 1, wherein the target particle is recovered on a wall surface side close to the center of the spiral of the micro flow channel.

4. The classification method according to claim 1, wherein the target particle is recovered in the vicinity of the center of the spiral of the micro flow channel.

5. The classification method according to claim 1, further comprising:
generating a droplet, and successively enclosing the classified target particle in the droplet.

6. The classification method according to claim 1, wherein
a plurality of the target particles are present, and
the relation of Dₑ/Rₑₚ≤4.68 is established between the particle Reynolds number Rₑₚ and the Dean number Dₑ for each of the target particles.

7. The classification method according to claim 1, wherein the target particle is a human peripheral blood mononuclear cell (PBMC).

8. A micro fluid device comprising:
a micro flow channel having a spiral shape; and
an inflow unit disposed in the micro flow channel and configured to cause a fluid to flow into the micro flow channel, wherein
the micro flow channel classifies target particles as recovery targets contained in the fluid flowed into the micro flow channel, and
a relation of Dₑ/Rₑₚ≤4.68 is established between a particle Reynolds number Rₑₚ and a Dean number Dₑ in a case of causing the fluid to flow into the micro flow channel under a predetermined condition for a combination of the micro flow channel and the target particle in the classification.

9. The micro fluid device according to claim 8, wherein Rₑₚ>0.071 and 0.38<Dₑ<0.78 are further established for the combination of the micro flow channel and the target particle.

10. The micro fluid device according to claim 8, further comprising:
a first recovery unit configured to recover the target particle on a wall surface side close to the center of the spiral of the micro flow channel.

11. The micro fluid device according to claim 8, further comprising:
a second recovery unit configured to recover the target particle in the vicinity of the center of the spiral of the micro flow channel.

12. The micro fluid device according to claim 8, further comprising:
an enclosing unit disposed in the micro flow channel, and configured to generate a droplet and successively enclose the classified target particle in the droplet.

13. The micro fluid device according to claim 8, wherein
a plurality of the target particles are present, and
the relation of Dₑ/Rₑₚ≤4.68 is established between the particle Reynolds number Rₑₚ and the Dean number Dₑ for each of the target particles.

14. The micro fluid device according to claim 8, wherein the target particle is a human peripheral blood mononuclear cell (PBMC).

15. A method for manufacturing a micro flow channel, the method comprising:
forming a micro flow channel having a spiral shape, wherein
at the forming,
the micro flow channel is formed so that, in a case of causing a fluid containing a target particle as a recovery target to flow into the micro flow channel under a predetermined condition, a relation of Dₑ/Rₑₚ≤4.68 is established between a particle Reynolds number Rₑₚ and a Dean number Dₑ for a combination of the micro flow channel and the target particle.

16. The method for manufacturing the micro flow channel according to claim 15, wherein, at the forming, the micro flow channel is formed by performing injection molding with a resin material using a mold.

17. A method for producing a particle-containing fluid to produce, from an input fluid containing target particles and other particles, an output fluid in which a ratio of the target particles to the other particles is increased, the method comprising:
causing the input fluid to flow into a micro flow channel having a spiral shape;
classifying the target particles; and
recovering the fluid on the target particle side after being classified as the output fluid, wherein
a relation of Dₑ/Rₑₚ≤4.68 is established between a particle Reynolds number Rₑₚ and a Dean number Dₑ for a combination of the micro flow channel and the target particle at the classifying.

18. The method for producing the particle-containing fluid according to claim 17, wherein the target particle is a cell.
